(19) United States
(12) Patent Application Publication
(10) Pub. No.: US 2007/0084283 A1
(43) Pub. Date: Apr. 19, 2007

(54) Safety tank level gauging system

(75) Inventors: Bradley T. Carlson, Cypress, TX (US); Ronnie Hughes, The Woodlands, TX (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: BJ Services Company, Houston, TX (US)

(21) Appl. No.: 11/252,397

(22) Filed: Oct. 18, 2005

(51) Int. Cl. G01F 23/28; G08B 21/00

(52) U.S. Cl. 73/290 V; 340/621

(57) ABSTRACT

An apparatus and method is disclosed to automate the measurement of the fluid levels of individual tanks used at the work site of an oil well. An ultrasonic transducer may be removably attached to each tank at the site. The fluid level of each tank may be determined from the time elapsed from the transmission of an ultrasonic signal from the transducer and when a signal reflected from the fluid is received at the transducer. The transducer may wirelessly transmit a signal representative of the fluid level to a receiving unit. The receiving unit may be able to instantaneously determine the overall fluid flow rate from the tanks based on the fluid levels when compared to previous fluid levels. The transducers may take fluid level measurements at regular intervals or may make measurements only when directed by the receiving unit.

### BACKGROUND OF THE INVENTION

1. Field of the Invention

The present invention relates generally to a gauging apparatus and method for measuring the level of fluid in tanks in the oilfield service environment.

2. Description of the Related Art

In the oilfield service industry, a work site may contain numerous tanks for holding liquid or other material. One such type of tank is for holding fracturing fluid used to stimulate oil and gas wells. It is important to monitor the fluid levels of each tank in an attempt to monitor the amount of fracturing fluid being used, as well as to know when replacement tanks or the re-filling of tanks is needed. This can be rather difficult task as it is common for a work site to have between twenty to fifty tanks on site. The relatively large number of tanks can make it difficult to determine the amount of fluid being used because the change in fluid level should be constantly monitored in each tank. The level of fluid in each tank may then be used to calculate the volume of liquid remaining the in each tank, which can be estimated based on the shape and dimensions of the tank. The tanks in a large group of tanks may be of various shapes and sizes making this calculation relatively difficult and time consuming. Further, the large number of tanks makes it difficult to measure the fluid level simultaneously in each tank. Real-time measurements would advantageously provide an accurate real-time measurement of the amount of fluid being used.

In the past, the fluid level in each tank was done by “strapping” tanks. A worker “straps a tank” by manually inserting a dipstick into the tank to determine the fluid level. Upon removal, the wet portion of the dipstick is observed to determine the current fluid level of the tank. This method can be expensive, as it requires excessive time and labor to measure the liquid level of each tank. Additionally, the overall data provided by this measuring system lacks accuracy because of the elapsed time between the measurements taken of the first tank and of the last tank.

The difficulties associated with the strapping tank method are exasperated when making such measurements during inclement weather. In inclement weather, this procedure can prove unsafe. Fracturing fluid tanks are generally large rectangular shaped vessels, but some fracturing fluid tanks may be cylinders oriented longitudinally along the ground, which are more difficult and dangerous to work on top of because of the curved top surface. “Strapping a tank” requires a worker to climb up onto the tank, which is usually over ten feet high, and then make the measurement by inserting a dipstick. The worker then must read the measurement from the dipstick and record the measurement before descending from the tank. All of these acts may have to be done on a tank that is wet or icy. Additionally, the worker may have to take these manual measurements during conditions that are windy, extremely hot, or severely cold. Each of these inclement conditions increases the likelihood of an accident occurring while measuring each and every tank at the work site. The size of these tanks can cause serious injury if the worker were to slip or fall off.

Another potential problem of the current method is the accuracy of each individual measurement. Specifically, the accuracy depends directly on the method the worker measures and reads the liquid level from the dipstick. Occasional errors in measurements will likely result due to the manual nature of the measurement. The propensity to make errors may be increased due to the strenuous task of measuring the fluid levels of large numbers of tanks at a work site or due to severe weather conditions.

Measuring the fluid levels in each tank is performed to determine the amount of fluid being used by the work site. By knowing the dimensions of a tank, the fluid level allows the volume of liquid remaining in the tank to be determined. The overall change in volume of a group of tanks indicates the amount of fluid being used over measuring time period. However, the method described above may not allow for an instantaneous calculation of flow rate of the system due to the amount of time required to measure and record the fluid level of each and every tank. Further, inaccurate measurements, which will likely be present in manual measurements, will also decreases the accuracy in the flow rate calculations. Additionally, the flow rate out of the tanks may not remain constant. A greater number of tanks present at a site increase the probability that the overall flow rate of the system may have changed between the time the first and last measurements were taken.

“Strapping” a tank also requires that a worker be exposed to the fluid contained in the tank. Often this fluid may be hazardous or present harmful results to humans if exposed over an extended length of time.

Monitoring the mixture level in proppant bulk trucks also presents some similar problems. Proppant is comprised of particles, such as sand or sintered bauxite, that are mixed with fracturing fluid to assist in holding factures open after a well has been subject to fracturing fluid. A worker is often required manually take a measurement of the proppant in the hopper of a truck. This can be a less-than-safe task for the worker as the proppant could shift or the worker could possibly fall into the hopper. Also the proppant in the hopper of a truck may not be level, but instead be at an angle making it more difficult to a worker to determine the amount of proppant remaining in the hopper.

Fracturing fluid tanks are often moved from work site to work site as needed and may even be moved on a daily basis. Upon relocation of the tanks, the tanks must be refilled with fracturing fluid, as well as hydraulically connected to the new work site. One way to measure the fluid levels in each tank would be to attach a sensor to each tank and then connect each sensor to a central processor to monitor the fluid levels. However, the frequent movement of the tanks may limit the use of a system of sensors wired to a central processor due to the time required to disconnect and reconnect the wires to configure the system, in addition to the time required to refill and hydraulically connect each tank.

In light of the foregoing, it would be desirable to provide a measuring apparatus and method that did not require the manual measurement of the level of fluid or proppant in a tank. It would also be desirable for an apparatus to automate the measurement of fluid level in the tanks at a work site eliminating the need to have a worker repeatedly climb onto each tank to make manual measurements. Further, it would be desirable for an apparatus or method to provide for the instantaneous measurement of all tanks connected as a system at a work site and allowing the accurate measurement of flow rate of the fluid out of the system of tanks. It would also be desirable to an automated measurement system, which would eliminate or minimize the need to expose workers to harmful materials. Additionally, it would be desirable for an apparatus or method to utilize wireless technology to minimize the configuration of connecting a number of sensors to a central processing unit to monitor the fluid level in each tank.

The present invention is directed to overcoming, or at least reducing the effects of, one or more of the issues set forth above.

### SUMMARY OF THE INVENTION

The present application includes a system and method for determining the level of a liquid or fluid material contain in a tank. Further, the system can monitor the individual levels of a network of tanks. By knowing the dimensions of each individual tank and monitoring the fluid levels, the system is capable of determining the fluid flow rate of material leaving the group of tanks as well as the fluid flow rate for each individual tank. The system may be comprised of a number of ultrasonic transducers or level sensors, hereinafter referred to as transducers, wherein at least one transducer is mounted on an interior wall of each tank. At least one, transducer measures the fluid level by transmitting an ultrasonic signal to the fluid material in the tank and by receiving an ultrasonic signal reflected off the surface of the fluid material. Time-of-flight circuitry is used to determine the distance from transducer to the fluid material based on the time between transmission and reception of the ultrasonic signals. The volume of fluid remaining in a tank can be determined based on the geometry of the tank and the current fluid level.

Data or a signal representing the fluid level may then be transmitted, e.g. wirelessly, from each transducer in the system to a receiving unit. In addition, each transducer may be assigned a unique identification or address that is transmitted along with the data so the receiving unit can properly correlate the data with the appropriate tank. The receiving unit includes necessary algorithms to calculate the fluid flow rate of material exiting the entire tank system based on the data received from the transducers. Additionally, the unit can calculate the fluid flow rate of material exiting each individual tank based on the data received from the respective transducer. The system may be configured to have the transducers transmit ultrasonic signals at regular intervals, such as every fifteen minutes, or could be configured to transmit an ultrasonic signal upon receiving the reflecting signal of the prior transmission. The unit may include in memory the dimensions and volumes of a number of tanks typically used in a particular application.

In an alternative embodiment, the transducer may include means for both wirelessly transmitting and receiving data. Such means could include any wireless device, such as a radio transceiver for example, as would be recognized by one of ordinary skill in the art having the benefit of this disclosure. The unit could then direct such transducers to measure the fluid level in its respective tank. The unit may send directives to the transducers at regular intervals or directives could be sent upon manual instructions by an operator of the unit. In some embodiments the transducers could go into a standby mode between measurements to conserve energy.

One embodiment of the present disclosure overcome the issues addressed above by combining ultrasonic and wireless technology to automate the process of gauging the fluid level in a fracturing fluid tank. The system may include a level sender unit that a small, e.g. 1.5″ by 6″, portable battery power unit suspended in the tank over the fracturing fluid on a bracket. A clamp or magnetic mount easily attaches the bracket. The units sense the level of the tanks by an ultrasonic range finder. This information is sent via a radio link to a small portable handheld unit, which may be about the size of a calculator, that monitors all the tanks on a given job site. Multiple handheld units can all read the same information. The handheld unit also has a data output for interface to a computer system in the well treatment analyzer vehicle. The handheld nature of the device allows an operator to verify and/or calibrate the system while actually viewing the tanks if desired. The handheld unit would also display flow rate as a backup to the primary job flowmeters. Small inexpensive ultrasonic and radio transmitter modules are currently available which make it possible to construct this unit to be very small and rugged with an extended battery life, which may be several weeks up to several months, for a reasonable cost. This same embodiment could also be used to monitor the level in proppant bulk trucks and help reduce potential safety hazards in monitoring the proppant level.

One embodiment of the present disclosure is a system for measuring a fluid level in multiple tanks containing a fluid, comprising at least one transducer attachable to an interior of each tank, wherein the at least one transducer is adapted to produce a signal indicative of the fluid level in the tank and to wirelessly transmit the signal and at least one unit that is in communication with the at least one transducer. The at least one transducer may include a wireless transceiver. The at least one transducer may produce a signal indicative of the fluid level in the tank and wirelessly transmits the signal when directed by the at least one unit.

In one embodiment, the system may include a bracket mounted to each tank and the at least one transducer may be attachable to the bracket. The at least one transducer may be magnetically attachable to the bracket. Alternatively, a clamp may attach the at least one transducer to the bracket.

In another embodiment of the system, the at least one unit may determine the flow rate of fluid exiting each tank from a change in volume of each tank, which is calculated using the difference of two signals wirelessly transmitted indicative of the fluid level of each tank and the flow rate may be determined by dividing the change in volume with the time that elapsed between the transmission of the two signals. The unit may further determine the combined flow rate of the fluid exiting all of the tanks. In some embodiments, the at least one unit may be a handheld device.

The at least one transducer of the system may be an ultrasonic transducer. Additionally, the at least one transducer may include a transmitting transducer, a receiving transducer, and a time-of-flight measurement circuit. The at least one transducer may be powered by a battery. The transducer in each tank may have a unique identifier, which is wirelessly transmitted along with the signal indicative of the fluid level.

One embodiment of the present disclosure is a process of measuring a fluid level in a tank containing a liquid comprising the steps of installing a bracket to an interior of the tank; attaching a transducer to the bracket; transmitting an ultrasonic signal from the transducer; receiving a reflection of the ultrasonic signal off the liquid of the tank, wherein the reflection is received by the transducer; calculating the level of the liquid of the tank based on time-of-flight of the ultrasonic signal; generating a signal in the transducer indicative of the liquid level of the tank; wirelessly transmitting the signal indicative of the liquid level; and receiving the signal indicative of the liquid levels with at least one unit.

The process may include the step of calculating the flow rate of liquid leaving each tank by calculating a change in volume of the tank from two received signals indicating the liquid level of the tank and dividing the change in volume of the tank by the time elapsed between receipt of the two signals. Additionally, the process may include the step of determining the combined flow rate of liquid leaving the multiple tanks. The transducer of the process may be attachable to the bracket by a magnet or a clamp. In one embodiment of the process, the level of liquid inside each tank may be calculated and transmitted at regular intervals. Alternatively, the level of liquid inside each tank may be constantly calculated and transmitted to the at least one unit.

Another embodiment of the present disclosure is an apparatus for measuring the level of a material contained in a tank that includes means for attaching a device to the interior of the tank, means for determining the level of the material contained in the tank with the device, means for transmitting a signal representative of the level of material, and means for receiving the signal.

### BRIEF DESCRIPTION OF THE DRAWINGS

FIG. 1 shows a cutaway view of a fracture fluid tank 10 with a transducer 30 attached to a bracket 40 mounted to the side of the tank 10.

FIG. 2 shows an embodiment of the present disclosure of a unit 90 that receives transmitted signals from a transducer.

While the invention is susceptible to various modifications and alternative forms, specific embodiments have been shown by way of example in the drawings and will be described in detail herein. However, it should be understood that the invention is not intended to be limited to the particular forms disclosed. Rather, the intention is to cover all modifications, equivalents and alternatives falling within the spirit and scope of the invention as defined by the appended claims.

### DESCRIPTION OF ILLUSTRATIVE EMBODIMENTS

Illustrative embodiments of the invention are described below as they might be employed in the use of designing an apparatus or system to measure the fluid level of a tank or a network of tanks. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Further aspects and advantages of the various embodiments of the invention will become apparent from consideration of the following description and drawings.

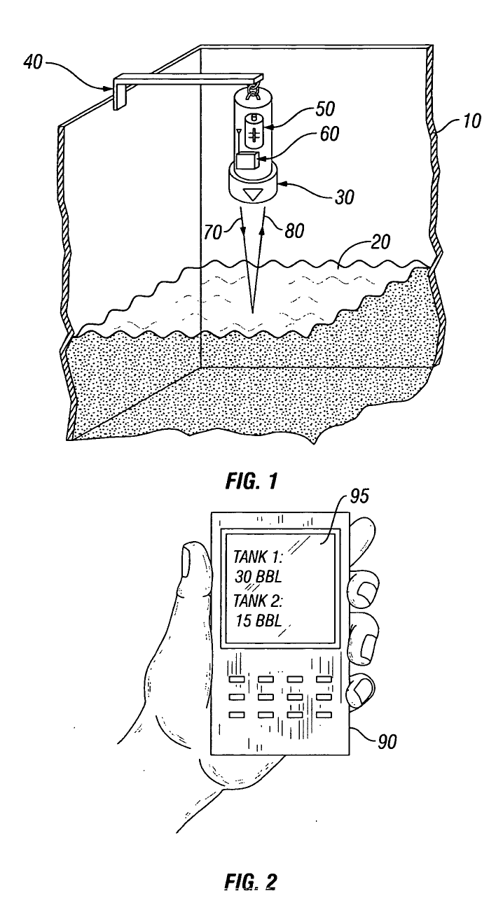

As shown in FIG. 1, a system to measure the fluid level of a fracturing fluid tank 10 may include a transducer 30; such as commercially available model series 9000 manufactured by SensComp, Inc. of Livonia, Mich., attachable to a bracket 40 mounted to an interior side of the fracturing fluid tank 10. As such, the bracket 40 may comprise means for attaching a device to the interior of a tank. Any other means for attaching a device to the interior of a tank, such as a clamp, a magnet, or a fastener for example, may be used as would be known to one of ordinary skill in the art having the benefit of this disclosure. Alternatively, the transducer 30 may be attachable directly to the side of the fracturing fluid tank 10. The tank 10 of the present disclosure is not limited to a fracturing fluid tank, but could be any container, such as the hopper of a truck, containing a liquid or other fluid material, such as sand for example, as would be recognized by one of ordinary skill in the art having the benefit of this disclosure.

The transducer 30 of FIG. 1 may include a battery 50 and/or a communication device 60. The battery 50 may provide a power source to the transducer 30 for an extended period of time while installed inside of the tank 10. The communication device 60 allows the transmission of data concerning the fluid level to the unit 10 shown in FIG. 2. The communication device may be any means for transmitting a signal, such as a radio transmitter, a radio receiver, a radio transceiver, or a infrared transmitter, as would be known by one of ordinary skill in the art having the benefit of this disclosure. The communication device 60 may be the commercially available radio transmitter model MC13192 provided by Freescale Semiconductor, Inc. of Austin, Tex. Alternative means for the wireless transmission of data could be used in place of the radio transmitter as would be evident to one of ordinary skill in the art having the benefit of this disclosure. In an alternative embodiment, the transducer 30 may include both a radio transmitter and a radio receiver that would allow the transducer 30 to be controlled remotely. The means for transmitting a signal may be compatible with the 802.11 IEEE standard.

To measure the fluid level in the tank 10, the transducer 30 may include means for determining the level of the material contained in the tank such as an ultrasonic signal. Any other means for determining the level of material in a tank, such as a radar signal or a laser for example, may be used as would be apparent to one of ordinary skill in the art having the benefit of this disclosure. The transducer 30 may send an ultrasonic signal 70 towards the liquid 20 contained in the tank 10. The transducer 30 receives the ultrasonic signal 80 reflected off the surface of the liquid 20. In one embodiment the transducer 30 may be comprised of a transmitting transducer for transmitting an ultrasonic signal 70 to the fluid 20 and a receiving transducer to receive the ultrasonic signal 80 reflected by the fluid 20. In some embodiments, the transducer may include time-of-flight measurement circuitry (not pictured) to determine the fluid level based on the arrival time of the reflected ultrasonic signal 80. Alternatively, the unit 90, as shown in FIG. 2, may include time-of-flight circuitry (not pictured).

FIG. 2 shows one embodiment of unit 90, which includes a display 95. The display 95 may indicate the fluid level, volume, or flow rate of each individual tank 10 in the system. The unit 90 may communicate wirelessly with the transducer 30. The unit 90 may include means for receiving a signal from the transducer 30, such as a radio receiver. Any means for receiving a signal, such as a radio transceiver, may be used as would be recognized by one of ordinary skill in the art having the benefit of this disclosure. In some embodiments, the unit 90 may also include a radio transmitter to allow the remote control of individual transducers 30. The unit 30 may be a hand-held device or alternatively could be a stationary unit. The unit 30 may include memory in which various information could be stored such as the dimensions and volume of typical tanks.

Although various embodiments have been shown and described, the invention is not so limited and will be understood to include all such modifications and variations as would be apparent to one skilled in the art.

1. An system for measuring a fluid level in multiple tanks containing a fluid, comprising:
at least one transducer attachable to an interior of each tank, wherein the at least one transducer is adapted to produce a signal indicative of the fluid level in the tank and to wirelessly transmit the signal; and
at least one unit that is in communication with the at least one transducer.

2. The system of claim 1, wherein the at least one transducer includes a wireless transceiver.

3. The system of claim 2, wherein the at least one transducer produces a signal indicative of the fluid level in the tank and wirelessly transmits the signal when directed by the at least one unit.

4. The system of claim 1, further comprising a bracket mounted to each tank, wherein the at least one transducer is attachable to the bracket.

5. The system of claim 4, wherein the at least one transducer is magnetically attachable to the bracket.

6. The system of claim 4, wherein a clamp attaches the at least one transducer to the bracket.

7. The system of claim 1, wherein the at least one unit determines the flow rate of fluid exiting each tank from a change in volume of each tank calculated using the difference of two signals wirelessly transmitted indicative of the fluid level of each tank and the time that elapsed between the transmission of the two signals.

8. The system of claim 1, wherein the unit determines the combined flow rate of fluid exiting the multiple tanks.

9. The system of claim 1, wherein the at least one unit is a handheld device.

10. The system of claim 1, wherein the at least one transducer is an ultrasonic transducer.

11. The system of claim 10, wherein the at least one ultrasonic transducer transmits an ultrasonic signal, receives an ultrasonic signal and has a time-of-flight measurement circuit.

12. The system of claim 1, wherein the at least one transducer is powered by a battery.

13. The system of claim 1, wherein the transducer in each tank has a unique identifier, which is wirelessly transmitted with the signal.

14. A process of measuring a fluid level in a tank containing a liquid, the steps comprising:
installing a bracket to an interior of the tank;
attaching a transducer to the bracket;
transmitting an ultrasonic signal from the transducer;
receiving a reflection of the ultrasonic signal off the liquid of the tank, wherein the reflection is received by the transducer;
calculating the level of the liquid of the tank based on time-of-flight of the ultrasonic signal;
generating a signal in the transducer indicative of the liquid level of the tank;
wirelessly transmitting the signal indicative of the liquid level; and
receiving the signal indicative of the liquid levels with at least one unit.

15. The process of claim 14, further comprising the step of calculating the flow rate of liquid leaving the tank by calculating a change in volume of the tank from two received signals indicating the liquid level of the tank and dividing the change in volume of the tank by the time elapsed between receipt of the two signals.

16. The process of claim 15, further comprising the step of determining the combined flow rate of liquid leaving a plurality of tanks.

17. The process of claim 14, wherein the transducer is attachable to the bracket by a magnet or a clamp.

18. The process of claim 14, wherein the level of liquid inside each tank is calculated and transmitted at regular intervals.

19. The process of claim 14, wherein the level of liquid inside each tank is constantly calculated and transmitted to the at least one unit.

20. An apparatus for measuring the level of a material contained in a tank, comprising:
means for attaching a device to the interior of the tank;
means for determining the level of the material contained in the tank with the device;
means for wirelessly transmitting a signal representative of the level of material; and
means for receiving the signal.
